(19) United States
(12) Patent Application Publication
(10) Pub. No.: US 2007/0198401 A1
(43) Pub. Date: Aug. 23, 2007

(54) System and method for automatic evaluation of credit requests

(76) Inventor: Reto Kunz, Monchaltdorf (CH)

Correspondence Address: PAUL, HASTINGS, JANOFSKY & WALKER LLP, P.O. BOX 919092, SAN DIEGO, CA, 92191-9092, US

(21) Appl. No.: 11/653,927

(22) Filed: Jan. 17, 2007

Related U.S. Application Data
(60) Provisional application No. 60/759,542, filed on Jan. 18, 2006.

(51) Int. Cl. G06Q 40/00

(52) U.S. Cl. 705/38

(57) ABSTRACT

A system for credit request processing comprises an automated decision tool that is configured as a single point of entry for all credit requests for a lending entity. The automated decision tool is configured to receive client information data and data from a plurality of databases. The automated decision tool is configured to generate a scoring and a pricing output based on the credit request. Based on the scoring output, the credit request can further be classified as a “white” case that can be processed by a client advisor associated with the client, or as a “grey” case that is typically processed by a credit officer or similar entity within the lending entity. The system is further configured to produce the correct credit documents according to the decision logic and answers to the scoring questions based on the personal data for the specific client.

This application claims priority to U.S. Provisional Patent Application No. 60/759,542, filed Jan. 18, 2006, which is incorporated by reference herein in its entirety.

### BACKGROUND

1. Field of the Invention

The present invention relates generally to tools for managing credit. More specifically, the present invention relates to an information technology based end-to-end fully integrated automated credit evaluation/decision system

2. Background of the Invention

As financial institutions such as banks grow larger, financial institutions are beset with challenges to effectively manage credit requests.

One challenge is to effectively operate in an international environment in which practices may vary between locations, and a client advisor (CA) associated with a potential or current clients may reside in a different country than a credit officer (CO). Current paper based systems can hamper effective tracking and decisionmaking with regard to credit requests because of the heterogeneous and dispersed structure of many lenders, leading to variations in credit request processing as well as overall inefficiencies in moving from a credit request to a credit decision for multiple credit requests received by an institution.

In particular, current paper-based credit approval processes can be cumbersome, often entailing a non-user credit request form. The process for credit approval can prove confusing to a client advisor that is responsible for a client (or potential client) seeking credit, where the client advisor may typically have little experience in the credit approval process. The current processes can result in delays in reaching loan decisions with regard to a credit request. In addition, under current processes, client advisors may have little of no authority to approve credit facilities. The above drawbacks can result in a credit approval process that acts as a deterrent to offering credit to a client that may be completely creditworthy.

### BRIEF SUMMARY OF THE INVENTION

The present invention provides an information technology based end-to-end fully integrated automated credit evaluation/decision system. The system and method of the present invention ensure that credit decisions are based uniformly upon best practices and an institution wide knowledge base reflecting the collective wisdom and experience of the entire institution. The system is adapted to be used by client advisors of varying levels of experience in geographically diverse regions in a multi-national institution.

In one embodiment of the present invention, the system is configured to operate as a global system for automated credit evaluation/decision in a multinational financial institution operating in a plurality of jurisdictions, where the financial institution holds loans against which collateral is pledged. The financial institution has access to data records storing information including a loan identification (ID), client ID associated with each loan ID, collateral associated with each loan ID, a client advisor associated with each client ID, and jurisdiction information associated with each client ID.

Importantly, the system and method of the present invention are particularly designed for and useful in the context of the credit decision process relating to collateralized loans to existing customers of a financial institution that is holding the collateral. In this regard, the automated credit evaluation/decision system is integrated into an overall system (of processes and applications) that includes a credit monitoring and reporting system that allows continual monitoring of collateral and can access existing data from institution databases to determine, for example, the collateral or pledgeable assets a client has, the client's credit history with the lending institution (sometimes referred to as a “customer confidence index”), and the particular local regulatory and legal restrictions that apply to the client.

By virtue of this system and method architecture and the underlying information technology, it is possible to process credits requests immediately. This is not simply making a credit decision, but rather leveraging institutional knowledge to simplify the request intake (by using previously stored information), expediting a credit decision (by using information stored in the system regarding the collateral) based upon a consistent set of best practices (that reflect the collective wisdom and experience of the institution) and, where appropriate, generating and completing necessary documentation (electronic or paper) to complete the transaction.

The credit decision is output as “white” or “grey (standard)” or “grey non-standard.” If the decision is “white,” then the system will generate documents and solicit client signature immediately. If the decision is “grey standard,” then the system will generate documents and pass the documentation to the credit officer (but not solicit the client signature immediately). A “grey standard” decision is, in effect, a determination that standard documentation can be generated and populated, but not yet provided to the client immediately. If the decision is “grey non-standard,” then the system will not generate standard documents because special documentation would be required.

Automatic generation of documentation ensures that the correct documents are used and that the documentation cannot be altered. Thus the documentation used is the very best possible based upon the collective wisdom and experience of the institution. Naturally, automatic generation of documentation also improves efficiency and productivity and makes it possible to provide an exceptional “one-stop” client experience.

Another feature of the invention is a maintenance process/tool that allows the institution to review the details of the grey cases and statistics related to the number of grey cases to obtain feedback on why cases are grey and to improve the system and process.

The system and method of the present invention are designed to provide feedback to ensure continual improvement and learning of both users (typically client advisors) and the system itself. The client advisors using the system receive immediate feedback based upon the collective wisdom and experience of the institution. Immediate feedback on why a decision is grey, not white, is provided to the client advisor to improve their knowledge and future use of the system.

The system and method of the present invention also include auditing and control functionality to ensure that credit decisions are made based upon a consistent set of criteria that reflects the collective wisdom and experience of the institution. The system enforces the institutions best practices in terms of both the decision process and documentation and maintains records of any deviation.

An important aspect of the present invention is that the invention supports a further embodiment in which customers have direct access to the system, for example, through a web interface. In this direct access embodiment, customers are able to input the requested data and obtain an immediate decision on their credit request. If the request is granted, the loan documentation can be completed through the use of electronic signatures or through paper documentation that is created automatically.

The extent to which a client is allowed direct access can depend on a client confidence index that is calculated based on historical data and access to customer data within the system that is indicative of the available collateral. In a preferred embodiment the collateral is continually monitored to ascertain any changes to the credit risk.

In the direct access process, the information input by the customer and the decision may be routed to the client advisor as desired to keep the client advisor informed and to allow review by the client advisor.

In one embodiment of the present invention, a system for credit request processing comprises an automated decision tool that is configured as a single point of entry for all credit requests for a lender. The automated decision tool is configured to receive client information data and data from a plurality of business databases of the lenders. The automated decision tool is configured to generate a scoring and a pricing output based on the credit request. Based on the scoring output, the credit request can further be classified as a “white” case that can be processed by a client advisor associated with the client, or as a “grey” case that is typically processed by a credit officer or similar entity within the lender.

In one embodiment of the present invention, a method for processing a credit request comprises receiving credit request information associated with a client in an automated decision tool, scoring the credit request according to preset criteria accessible to the automated decision tool, classifying the credit request, based on the scoring of the credit request, as either a “white” or “grey” case, forwarding the case for evaluation to a client advisor if the case is classified as “white,” and forwarding the case to a credit officer if the case is classified as “grey.” In one variant, the determination of whether the case is classified as “grey” or not is based on a combination of the scoring of the request and the decision logic employed by the automated decision tool.

In another embodiment of the present invention, a method for credit request processing comprises performing credit transactions using an automated credit request system having a first set of decision criteria, evaluating results of automated credit request transactions performed using the first set of decision criteria, flagging for reporting to a reviewer one or more decision criterion from the first set of decision criteria if that decision criterion meets a threshold for correlation to credit requests unexpectedly classified as “grey,” and revising one or more flagged decision criteria of the first set of decision criteria, according to the reviewer determination.

### BRIEF DESCRIPTION OF THE DRAWINGS

FIG. 1 is a schematic diagram that illustrates a reference process that is used for processing of a credit application.

FIG. 2 is a systematic diagram that illustrates a system for credit request processing, arranged according to one embodiment of the present invention.

FIG. 2b illustrates an exemplary credit request system for storing and providing credit request related data as anonymized data, according to one embodiment of the present invention.

FIG. 3 is a schematic diagram that illustrates the relation between inputs to an automated decision tool, operations performed by the automated decision tool, and outputs of the automated decision tool, in accordance with an embodiment of the present invention.

FIG. 4 illustrates exemplary steps involved in a method for credit request processing, in accordance with another embodiment of the present invention.

FIG. 5 is a schematic diagram that illustrates the operation of a decision logic process to process a credit request, in accordance with one embodiment of the present invention.

FIG. 6 is a flowchart that illustrates a division of labor between various lender parties for processing a client credit request, in accordance with one embodiment of the present invention.

FIG. 7 is a schematic diagram that illustrates an exemplary process flow in the case of a credit request that is classified as “white,” in accordance with an embodiment of the present invention.

FIG. 8 is a schematic diagram that illustrates an exemplary process flow in the case of a credit request that is classified as “grey,” in accordance with an embodiment of the present invention.

FIG. 9 is a schematic diagram that depicts details of process inputs used to determine pricing of a credit request using an automated decision tool, in accordance with another embodiment of the present invention.

FIG. 10 illustrates exemplary steps involved in a method for improving credit request processing, in accordance with another embodiment of the present invention.

FIG. 11 illustrates exemplary steps involved in a method for improving credit request processing, in accordance with another embodiment of the present invention.

### DETAILED DESCRIPTION

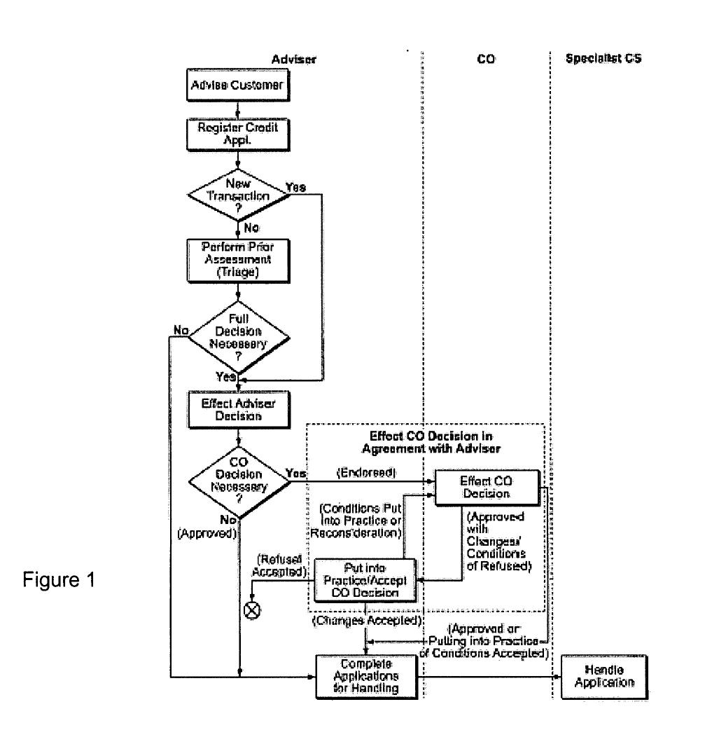

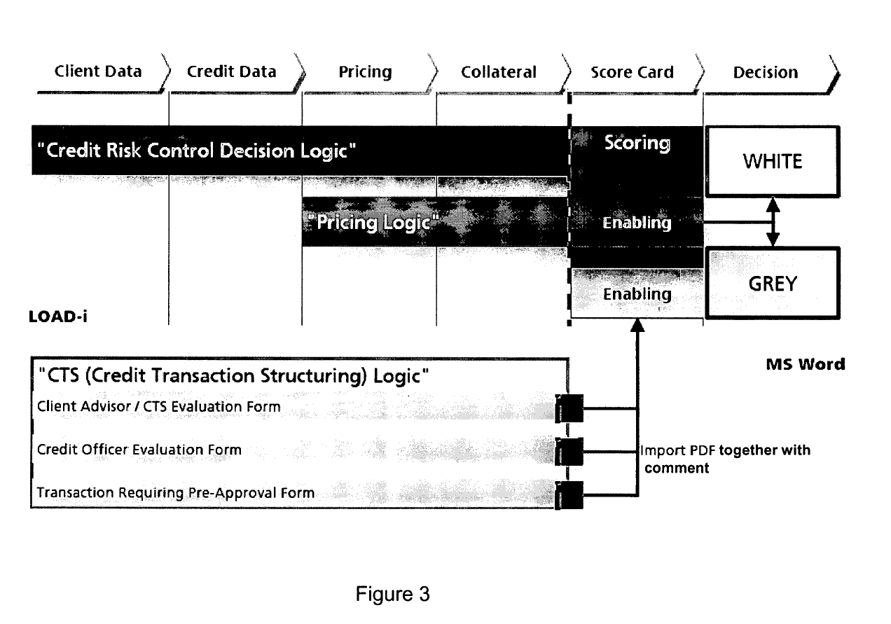

FIG. 1 is a schematic diagram that illustrates a reference process that is used for processing a credit application. FIG. 1 clarifies aspects of the invention described further below with respect to FIGS. 3-11. As illustrated in FIG. 1, three different processing roles are involved in the processing of a credit request. Persons responsible for the care of customer relations are often termed advisors or CAs. Advisors work at the “front,” in “advice” and in “marketing” credit decisions—if credit decisions cannot be decided immediately by advisors, the decisions can ultimately be made by credit officers (COs). Credit officers are often also designated as decision-makers. Finally, ultimate handling—drawing up the contract, payments, etc.—is undertaken by specialists in the credit services (CS).

In an advisory interview held by the CA with the customer, among other things the customer's credit needs are determined. The CA registers the credit applications determined in the advisory interview. If there are changes to existing credit commitments with little or no risk attached, in order to minimize the amount of work, a full risk assessment of the customer's position (full decision) is dispensed with. Low-risk changes of this kind are identified by performing a prior assessment (triage). The prior assessment is done for each application. If it is possible to dispense with a full decision for all the applications of an opposite party combined in a submission, they can be directly supplemented using information relevant to the handling, and then released for handling. New transactions, on the other hand, always require a full decision. Financing potential (with commercial customers) or affordability (with private customers) may be used as a measure of the credit standing of a customer.

For the decision as to whether and under what conditions the desired credit can be granted to a customer (client), the credit application (possibly consisting of several individual applications)—together with any existing credit commitment—is balanced against the client creditworthiness and the client securities, in other words the credit standing of the customer. To assess the customer's creditworthiness, value is attached to an overall customer profile.

The decision-making process of the CA may be supported by a decision plan defined in advance. The registered financial figures and responses can be used to categorize the credit submission as “white,” “grey,” or “declined.” In a “white” decision, with sufficient authority, the CA can approve the submission at once. The responsibility for the decision lies entirely with the CA. Once the CA has approved the submission, handling of the credit granting process is continued immediately. If there is a “grey” or declined system decision or, if the CA has been granted too little authority, a CO decision is necessary. If the CA endorses the credit submission, the CA forwards it immediately to a CO with reasons for endorsement.

After analyzing the submission, the CO can approve the submission unchanged, approve it with changes, approve it with conditions, or refuse or reject it. If the CA's assessment is incomplete, or if it obviously does not represent the current view of the customer or his securities, the CO rejects the submission. If a submission comprises a plurality of applications, for example, both uncritical applications, which the CO can simply approve, and applications whose approval is to be linked to conditions, the CO can make a separate decision for each application instead of for the entire submission. Moreover, the CO can also set measures and deadlines which the CA must put into practice. The CO then returns the entire submission to the CA.

In a next processing step, the CA can put into practice or accept the CO decision. The specific action performed in this step depends on the CO's decision. If the submission (or individual applications) is approved unchanged, the decision is concluded and the CA continues to complete the handling. If the CO has approved the submission with changes, the CA must confirm the CO's changes before “completion of handling” or the CA can put in an application for reconsideration. If the CO has approved the submission with conditions, the CA puts the conditions into practice in consultation with the customer. If the CA or the customer does not agree with the conditions, the CA can put in an application for reconsideration. If the CO has refused the submission and the CA does not agree with the CO's refusal, an application for reconsideration may be sent. Otherwise, the CA confirms the CO's refusal decision. If the CO has rejected the submission, the CA can draw up a new submission. The applications and latest adaptations to the customer profile drawn up as part of the rejected submission are adopted into the new submission.

If the CA has put into practice all the CO's conditions or if she puts in an application for reconsideration for the entire submission or individual applications from it, she returns the entire submission to the CO. If some of the applications in the submission have already been approved, these can be completed and put in for handling if this has been approved by the CO. If the submission or parts of it have been approved, the CA establishes the concrete products and conditions, sets the prices, and supplements additional information which is not relevant to the decision, but is relevant to the handling of the submission. In performing these functions, the CA adheres to the framework approved for the decision. The specialist in credit services finally handles the individual applications.

Because of the complexity of the above operations, it is desirable that unneeded interactions be reduced or eliminated to reduce the typical time and cost of processing credit requests. For example, as detailed above with respect to FIG. 1, involvement of a CO in processing a credit request decision can involve a complex set of decisions and interactions with a CA. It is therefore useful, for example, to ensure that all properly “white” cases, that is, those that can be handled exclusively by the CA, are truly classified as “white,” so that needless interaction with the CO is avoided.

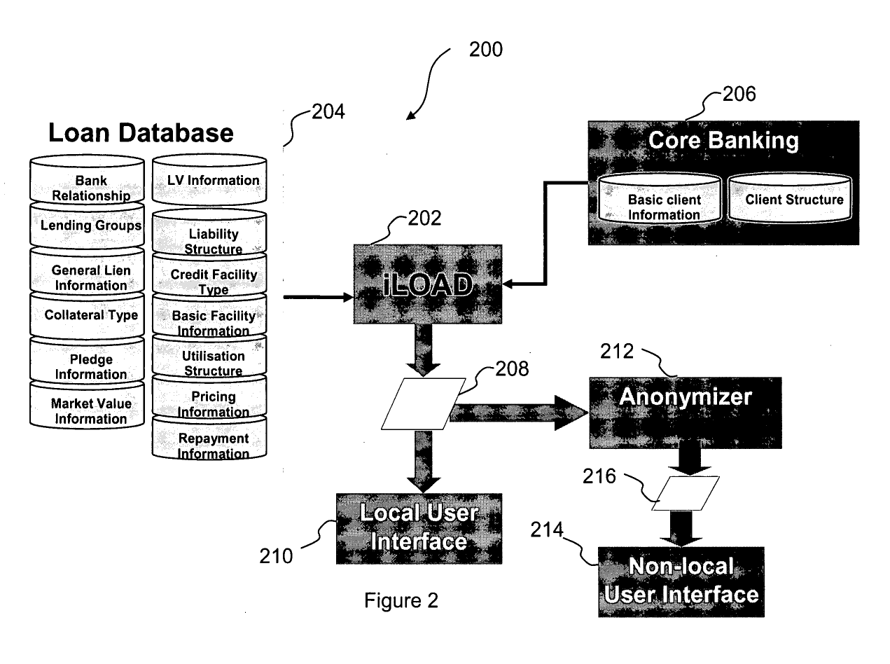

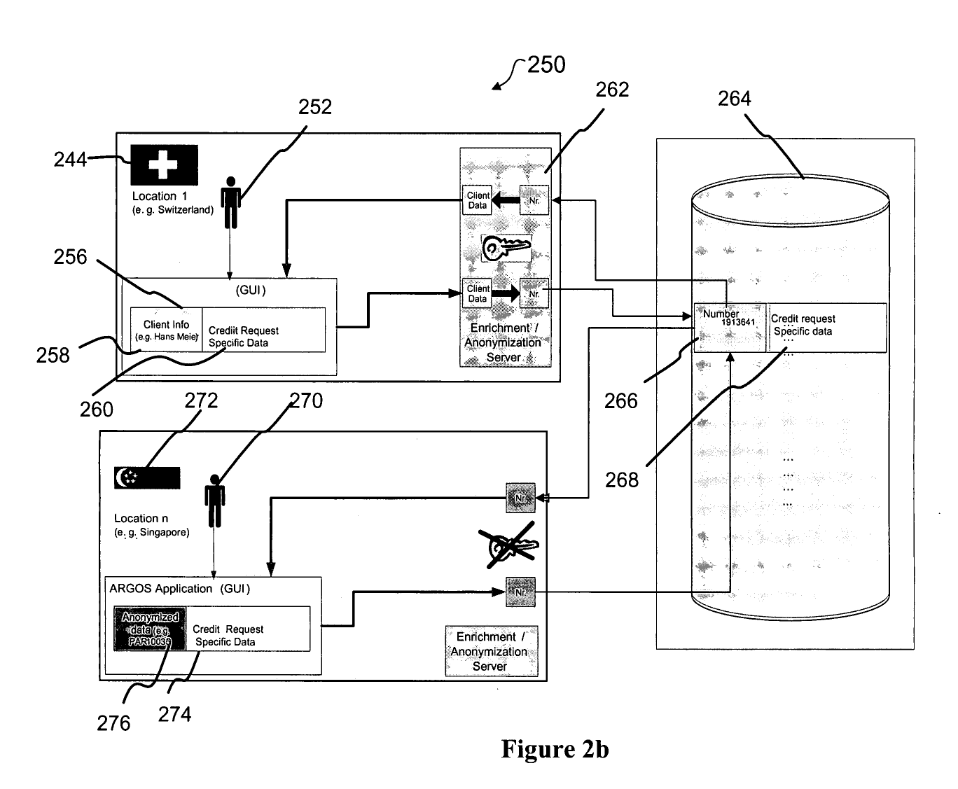

FIG. 2 illustrates a system 200 for credit request processing, arranged according to one embodiment of the present invention. System 200 includes an automatic decision tool 202 (iLOAD) that is coupled to inputs from core banking database 206 and loan database 204. Automatic decision tool 202 employs decision logic to operate on database inputs, such that automatic decisions are produced based on a set of inputs. In one embodiment of the present invention, system 200 is configured as a single point of entry for all credit requests for a lending institution. Access may be provided at dispersed locations, but the system is configured for tools such as automatic decision tool 202 to have access to global credit request data, and to employ a common evaluation process for credit requests. Within the loan database 204, exemplary databases, such as the following may be included: The existing Bank Relationship including names, addresses, account numbers; connections with other clients under the same facility (Lending Groups database); General Information database having general information concerning the lien (type of usage and credit products used); Collateral type database having detailed information on the type of collateral and some risk-determining factors, such as diversification, concentration, volatility; Pledge information database including information on the relationship of pledge (e.g. own, third); Market information database including information about the market value of the collateral; and several other databases containing information on the existing Liability Structure, Credit Facility Type, Basic Facility Information, Utilization Structure, Pricing Information and Repayment Information

In one embodiment of the present invention, automatic decision tool 202 can be employed to receive credit request information and classify the credit request into a “white” or “grey” category. As used herein, the term “white” denotes a category of credit request that is deemed to be routine, so that a lender employee such as a CA can finalize approval of the credit request. A categorization of the credit request as “white” indicates that the automated decision tool has already rendered a decision that the credit request should be approved, pending further routine processing of the credit request by a CA and other entities of a lender that are used for processing a loan application. In other words, the classification of a credit request as “white” denotes that the credit request should be accorded expedited approval. As used herein, the term “grey” denotes a category of credit request that by virtue of its complexity or other features, such as legal or regulatory requirements, is deemed to be non-routine and merits further review and careful scrutiny by, for example, a credit officer. Routine requests that might otherwise be deemed “white” credit requests may also be classified as “grey” if the monetary value of the request exceeds the authority of a CA. The classification of the credit request as “white” or “grey” is mutually exclusive, such that a request cannot be both “white” and “grey.”

In processing a request for a loan (credit request), automatic decision tool 202 can, for example, receive as inputs client data, credit data, pricing information, collateral data, and use the inputs to generate one or more outputs. The outputs include “scoring” information that can be used to further generate a classification of the credit request as “white” or “grey.” The outputs may further include pricing information, which automatically sets pricing of an approved credit request, for example.

In one embodiment of the present invention, system 200 is a web-based tool capable of operating standalone in a trusted environment and can be launched within any designated user working environment. The system has automated links to a core banking platform to authenticate users, to obtain client assets and liability data intraday or to transmit booking information of facilities approved back at the end of the day.

System 200 can be configured to furnish an electronic link from each branch-based satellite to a central administration unit for transfer of credit documentation files at the end of the day. Auto-approval and auto production of documentation of credit facilities can be performed, which is facilitated by interfaces to the documentation scanning and retrieval system. Additionally, system 200 supplies functionality which allows the processing of urgent intra-day credit requests. System 200 can be configured to fit into an existing credit delivery process without necessitating any material change to the process, at the same time as facilitating shifts of functional responsibilities, as described further below. In one embodiment of the present invention, system 200 is configured as the single point of entry for all credit requests, renewals, or amendments, such that it provides auto-approval functionality and creates full credit documentation for standard deals and produces credit request forms for non-standard deals.

In one embodiment of the present invention, the automated credit evaluation/decision system 200 is integrated into an overall system that includes a credit monitoring and reporting system that allows continual monitoring of client financial data, as described in U.S. Provisional Patent Application No. 60/759,590, filed Jan. 18, 2006, and U.S. patent application Ser. No. ______, entitled “System and Method for Credit Risk Detection and Monitoring,” filed Jan. 17, 2007, which are both incorporated by reference herein in their entirety.

In an embodiment of the present invention, system 200 comprises a plurality of decision logic modules that can be employed by one or more automated decision tools 202. One level of the decision logic is a core module that is commonly employed throughout system 200, which may operate on a global basis to evaluate credit requests from clients located worldwide. Another level of the decision logic comprises location-specific add-ons that are tailored to local (such as country-specific) needs, to aid in processing credit requests associated with the location of the origin of the credit request.

System 200 is configured to output credit request related data 208 that may be viewed by at local interface 210 of non-local interface 214. For example, the credit related data 208 could include a scorecard that classifies a credit request as “white” or “grey,” as well as client-related information, including the inputs to the scorecard. The local interface may comprise a graphic user interface viewable by a CA and a client, for example, who can review and discuss the information in the credit request data 208. In one embodiment of the present invention,—credit request related data 208 that is received by system 200 is provided to users at non-local interface 214 as anonymized data 216. Anonymized views may also be provided to all users wishing to access data related to the client credit request, but having no client relationship management responsibilities.

FIG. 2b illustrates an exemplary credit request system 250 for storing and providing credit request related data as anonymized data, according to one embodiment of the present invention. Client Advisor 252 in location 254 can view a client credit request related data record 256 that includes unanonymized client identifier 258, as well as credit request specific data 260. Record 256 can be transmitted through enrichment/anonymization server 262 to be stored in database 264. As depicted, location 254 may be in a first country, for example, Switzerland. Database 264 may, for example, be located in a second country. Record 256, after passing through sever 262 is provided as anonymized record 266 in database 264. Anonymized record 266 includes anonymized client identifier 268 that may be, for example, a number, rather than a client name, such as that in unanonymized identifier 258. This can be accomplished, for example, by configuring server 262 to assign client 252 a unique scrambled identifier. Accordingly, an outside user that is not authorized to see the unanonymous data, for example, a user in a second country, can access anonymized record 266, but views the credit request data without seeing the unanonymized client identifier, such as a client name. For example, the outside user 270 in location 272, who accesses database 264, can only view record 274 as an anonymized record that includes anonymized client identifier 276.

In one embodiment of the present invention, system 200 can be configured to anonymize data of all named clients by replacing data records with 5 stars [>>*****<<]. Each credit request may be rendered identifiable by a unique Request ID, and hence, cross-border communication of credit request data can take place without violating any compliance issue, since unanonymized data is kept only within the location of credit payment origin. If an authorized person outside the location of origin needs unanonymized information, the information can be supplied by a CA, for example, who is able to judge if the requestor is eligible to receive the solicited information.

FIG. 3 is a schematic diagram that illustrates the relation between inputs to an automated decision tool (such as tool 202), operations performed by an automated decision tool, and outputs of the automated decision tool, in accordance with an embodiment of the present invention. As illustrated, the automated decision tool employs a credit risk control (CRC) decision logic that includes as inputs client data, credit data, pricing information, and collateral information. An automated decision tool can be configured such that the CRC decision logic path is solely responsible for determining the approval of credit requests. As described further below, the automated decision tool can apply CRC logic to a question-answer type score card the answers to which are derived from the supplied inputs. Using such a score card format helps insure that the output scoring (which determines whether the credit (loan) request is classified as “white” or “grey”) and pricing values adhere to a lending organization's policies and legal and regulatory restrictions during a loan origination process. In one embodiment of the present invention, the credit request processing system is configured to require that unless all conditions of the pricing and the credit transaction structuring logic are met before producing a decision.

During a loan origination process, it may be standard practice to require that CAs, COs, and Credit Transaction Structuring Officers each have the opportunity to evaluate any credit request. System 200 is preferably configured to provide facilities to all users who evaluate a credit request. As soon as the evaluation process is completed, a system decision is enabled. In the example illustrated in FIG. 3, a scoring output is used to determine a decision as to whether the credit request is to be classified as “white” or “grey.” As illustrated in FIG. 3, pricing output information may be independently determined such that the pricing information is output together with the white/grey determination. Thus, in one configuration of the present invention, the same pricing output associated with a prospective loan, for example, may be automatically generated regardless of whether the credit request process is determined as falling into the “white” or “grey” category. It may be determined, for example, by an automated decision tool, that a loan is to be priced at 50 basis points above a standard benchmark, regardless of how the final decision on granting the loan is performed.

In the arrangement depicted in FIG. 3, a user is provided with the option to import files, such as .pdf files and attach them permanently to a credit request from which the import functions were initiated. In one configuration, a credit request system permits only one form type (e.g., CA/CTS Evaluation Form, CO Evaluation Form, or Transaction Requiring Pre Approval) to be attached to a particular credit request. Either a CA, Front Support personnel, or a Credit Transaction Structuring Officer may be authorized to import the CA/CTS Evaluation Form. A CTS refers to a unit of a creditor organization (such as Products & Services, Lending Products) that assists the CA in structuring and preparing large and complex credit requests in a way that allows the requests to be submitted with all information required according to the Lender's Credit Risk Policies, since such knowledge is not always available to the CA. In one example, for standard procedures, the CA Evaluation Form could be allocated for signing to a CA, CTS, Country Desk Head, or Supervisor, respectively, while if any exception-to-policy pricing issue prevails, signatures from more senior officials can be required. If the decision authority is within the scope of the automated decision tool, the automated decision tool can sign on behalf of the logged users by printing predefined characteristics at a predetermined space.

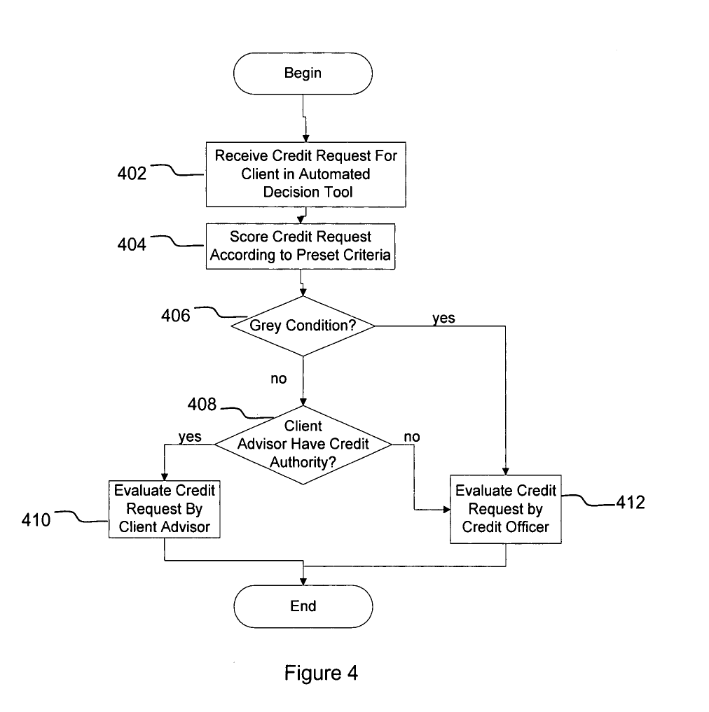

FIG. 4 illustrates exemplary steps involved in a method for credit request processing, in accordance with another embodiment of the present invention. In step 402, a credit request is received by an automated decision tool. The credit request may comprise a series of inputs related to a client, such as those discussed above with respect to FIGS. 2 and 3. The inputs may, in turn, come from a variety of dispersed sources such as client and business databases that each contain relevant information related to the credit request, collateral, and related transactions.

In step 404, the automated decision tool acts upon the inputs to score the credit request according to preset criteria. The preset criteria may be configured as a set of questions (discussed further below) related to the client and the type of loan being applied for.

In step 406, the automated decision tool determines if the credit request represents a “grey” condition based on the scoring process employed in step 404. In one configuration, the determination of a “grey” condition for the credit request may involve determination of answers to a series of yes/no questions. The decision logic is configured such that an answer to each decision criteria question yields either a “white” or “grey” determination. Based on the series of white/grey determinations corresponding to answers received for the series of decision criteria, the decision logic is further configured to determine whether the credit request merits an overall “white” or “grey” condition.

If a “grey” condition is determined to exist, then the process moves to step 412, where the credit request is sent to a CO or official with similar authority for evaluation. If a “grey” condition is not found, then the process moves to step 408.

In step 408, the automated decision tool checks to determine the amount of a credit request that is otherwise without “grey” scoring, and compares that to the authority vested in a CA associated with the client. The term “authority,” as used herein, generally refers to a monetary limit for which a CA (or other employee) can approve a prospective credit transaction. If the credit amount in the credit request exceeds the CA authority, the process moves to step 412. If the credit amount is within the authority of the CA, then the process moves to step 410.

In step 410, the CA evaluates the credit request and a final determination is made without intervention of a CO.

Table I below illustrates a series of exemplary decision criteria used to determine the classification of a credit request, in accordance with another embodiment of the present invention. Any or all of the criteria listed in Table I could be used to assign a credit request category (“white” or “grey”). In most cases, the decision criteria are structured as yes/no questions, while in some cases, other information is elicited from the questions.

TABLE I

| NO | DECISION CRITERIA | WHITE | GRAY |
|---|---|---|---|
| 1 | Is a current auditor's report available and submitted? | Yes | No |
| 2 | Have copies of the balance sheets and profit and loss statements for the past three | Yes | No |
| | financial years been provided? | | |
| 3 | Do the statutes or the constitutional documents allow the borrower to enter into | Yes | No |
| | the transaction? | | |
| 4 | Do the statutes allow the pledging party to pledge the assets concerned? | Yes | No |
| 5 | Does the intended purpose of the transaction comply with the declared purpose of the | Yes | No |
| | company, foundation, institution or trust as stated in the statutes? | | |
| 6 | Has a written and signed resolution/dividend payment decision by the board of | Yes | No |
| | trustees been submitted, insofar as the transaction concerns payment and/or | | |
| | provision of guarantee in favor of either the financial beneficiary (beneficial owner) or | | |
| | a third party? | | |
| 7 | Is the borrower a person who is part of a community of heirs, a person under | No | Yes |
| | guardianship, a minor or someone who does not have full capacity to act? | | |
| 8 | Is the borrower or the financial beneficiary an unwanted client due to the violation of | No | Yes |
| | CDB (Agreement on the Swiss banks' code of conduct with regard to the exercise of | | |
| | due diligence), PEP (politically exposed person), SIAP (part of a sensitive industry), | | |
| | reputation risk for [lender], etc. | | |
| 9 | Does the borrower (and/or their financial beneficiary) have other credit | No | Yes |
| | arrangements with >> <<in >>Country<<(whether as an individual or as financial | | |
| | beneficiary of a legal entity, etc.)? | | |
| | Please list all portfolio numbers associated with this credit relationship. | | |
| 10 | Is the transaction intended solely for the purpose of preserving or accumulating | No | Yes |
| | assets? | | |
| 11 | Is [the lender] in possession of a written request from the client for the required | No | Yes |
| | credit limit? | | |
| 12 | Is the financing purpose and loan structure defined plausible and transparent? | Yes | No |
| 13 | Is requested facility a fiduciary credit, which the bank grants in own name as a | No | Yes |
| | trustee, but invoicing and risk are carried by a third party, or is it a “back-to-back” | | |
| | transaction? | | |
| 14 | Is the proportionality of the requested margin limit (respectively transaction volumes) | Yes | No |
| | for derivative business given to the total assets status of the client and its vocational | | |
| | activity (viability and suitability of the request for credit are to be approved)? | | |
| 15 | Are assets held in the holding account in accordance with WM Policy No. 2 | Yes | No |
| | sufficiently diversified (no “single stock lending”, bulk risk, etc.)? | | |
| 16 | Are all conditions/measures and dates of the last request/review | Yes | No |
| | settled/fulfilled? | | |
| 17 | Are all conditions/measures from current credit agreements | Yes | No |
| | adhered to? | | |
| 18 | Is the domicile of the borrower identical to the domicile of the financial | Yes | No |
| | beneficiary? | | |
| 19 | Is there any additional information available, which could not be captured previously | No | Yes |
| | that would be relevant for the credit decision?. No/Yes | | |
| | If Yes, please specify. <Free text> | | |
| 20 | Is the domicile of any financial beneficiary or pledgor in a sensitive country as | No | Yes |
| | determined by [the lender]? | | |
| 21 | Is this transaction suitable for the Client's risk profile and, if not, has Compliance | Yes | No |
| | approval been obtained? | | |
| 22 | Has the indemnity form been signed for a credit card facility? | Yes | No |

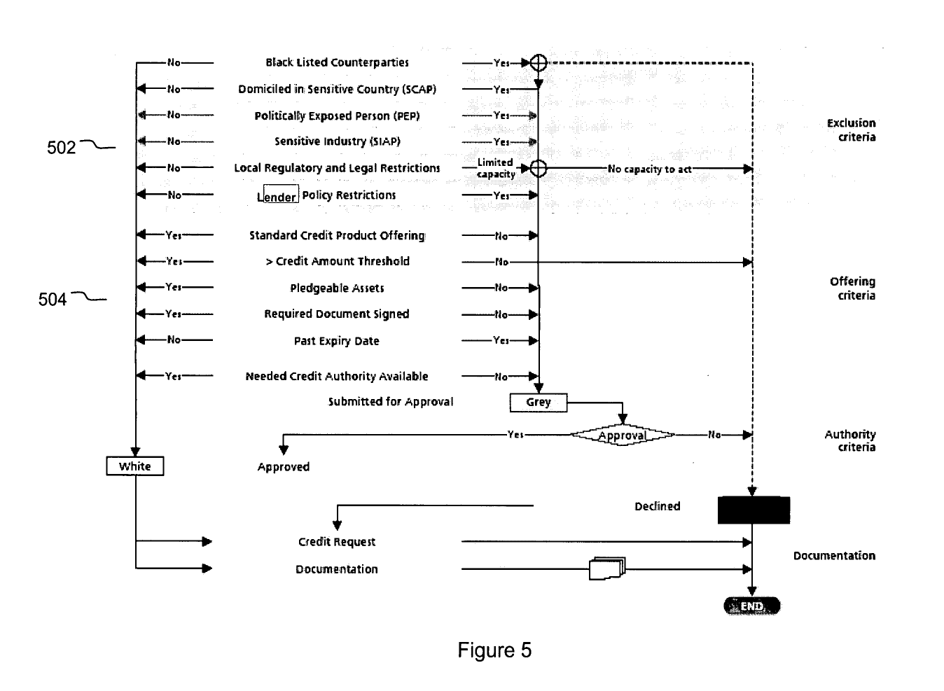

FIG. 5 is a schematic diagram that illustrates the operation of a decision logic process to process a credit request, in accordance with one embodiment of the present invention. Exclusion criteria 502 represent criteria that if met, yield a “grey” result, while offering criteria 504, if met, yield a “white” result. Thus, for instance, if the answer to the exclusion criteria question “is the borrower a politically exposed person” is “yes” the process leads to a “grey” status. If the answer to the offering criteria question “are there pledgeable assets available” is “yes” the process leads to a “white” result. The authority criteria, if answered in the affirmative, generally, but not always, lead to a classification as “white.” In some cases, decision criteria can be set such that an answer (such as “no capacity to act”) leads directly to a credit denial, a “declined” category. Once a loan is approved or denied, the process leads to a documentation stage.

In accordance with embodiments of the present invention, the credit application process for a client can be greatly streamlined. For example, during the initial stage of a loan application, a client can meet with a CA of a creditor institution to facilitate the loan application process. Equipped with proper documentation, the client provides the CA with information sufficient to answer a set of pre-determined questions that determine whether the client's loan can be given expedited treatment (is treated a “white” case). The information can be supplied to an evaluation program of an automated decision tool that is operable to receive data input (yes/no answers, etc) and to implement the exemplary decision logic shown in FIG. 5, for example. In one example, the CA is provided with a web-based GUI that includes a question menu, such as that shown in Table I. The CA in consultation with the client provides answers to each question, so that the credit request can be scored as “white” or “grey” according to the criteria discussed above.

A further aspect of the present invention incorporates the automatic selection and production of credit documentation during the request and approval process. Again capitalizing on the stored client background information, the system can automatically select the appropriate credit forms and populate the forms based on the background information and the answers to the decision criteria questions. For example, the system can select the forms based on applicable local regulations, legal restrictions, and the credit amount. In a “white” case, the documentation can be selected and printed automatically, and presented to the client for signature, such that the client can leave the office of the CA with an approved loan. In a “grey” case, the documentation can still be produced, but then routed to the CO for further consideration along with the decision criteria that led to the “grey” classification. If the CO approves the “grey” case, then the documentation is ready for presentation to the client.

Preferably, the automated decision tool and evaluation program are configured so that the questions and decision logic cannot be modified by a user. This ensures that when the evaluation program is complete, that is, when all of the questions have been answered, the scoring decision of the credit request is correct, and that the correct documents needed to complete the loan application process are printed for execution by the proper parties.

After the evaluation process is completed, the CA is provided with feedback from the automated decision tool, including the scoring of the credit request. In the case of a credit request scored as “grey,” the automated decision tool provides information as to why the request was classified as “grey.” For example, the evaluation program could provide a listing of all questions that produced a “grey” result.

Referring again to FIG. 4, in a preferred embodiment of the present invention, the determination step 406 could result in a “grey” status for the credit request if any decision criteria is answered so as to convey a “grey” status. Thus, a “white” status would only be assigned if all individual criteria also lead to a “white” categorization. If even a single answer is “grey,” the credit request is scored overall as “grey.”

Preferably, the automated decision tool and evaluation program are configured so that a scoring of the credit request is only provided to the user after all the entries to the predetermined questions in the program are complete. Accordingly, the user is not provided with advanced knowledge of which, if any, questions have generated “grey” results before the process is complete. This ensures that the user cannot strategically alter the answers during entry of answers to questions to generate a desired result. Nevertheless, in embodiments of the present invention, the user may be provided with a complete listing of questions, for example, that generated “grey” responses after the scoring is complete. The user, for example, a CA, may wish to alter the scoring if the user legitimately believes, for example, that a “grey” score was erroneously generated, but a record of the original scoring is preserved so that a complete record of the credit application process is available for later monitoring.

Although FIG. 5 illustrates the determination of a credit request status based on answers to a series of decision criteria questions, in configurations of the present invention, whenever possible, the automated decision tool replaces a question by appropriate data capturing and/or by algorithms. This results, for example, in more decision criteria questions that are decided by the automated decision tool performing deductions based on data entry. Thus, many of the decision criteria questions could be replaced by data entry, such that the credit processing system is able to determine a credit request score based at least in part on data input rather than solely or mainly on answers to a series of questions. An example of the use of data to replace a yes/no decision question is the determination of the lending value of available assets of the client compared to the requested credit. Rather than configuring the system to include questions as to the relative value of the assets compared to credit, the system can be configured to receive as inputs, the total value (lending or market value) of collateral/assets of the client, so that a determination can automatically be made as to whether the value exceeds that of the credit (also an input) request. Thus, the credit evaluation program is configured to include a minimal set of “yes/no” and related questions that are deemed essential to the evaluation process and need to be decided manually by a user.

An important aspect of the present invention provides an end-to-end credit request and approval process that capitalizes on client information already accessible to the credit request processing system. Referring to FIG. 2, the automatic decision tool 202 can access existing data from client database 206 to determine, for example, the collateral or pledgeable assets a client has, the client's credit history with the lending institution (sometimes referred to as a “customer confidence index”), and the particular local regulatory and legal restrictions that apply to the client. With this background information, the system 200 can pose decision criteria questions to the CA and score the credit request based on the background information, without requiring the CA to enter the background information again. This approach greatly increases the speed at which requests can be processed for existing clients, which often make frequent requests for credit.

In one embodiment of the present invention, the categorization of “grey” credit requests can be subdivided into standard and non-standard cases. Standard “grey” cases result when decision criteria would result in a “white” credit request, except for the fact that the credit authority of the requesting user (for example, a CA) is insufficient for obtaining credit approval. A non-standard “grey” case results when a mix of decision criteria is deemed non-standard. For example, decision criteria related to client type and facility type may be used to determine whether a credit request conforms to a standard type or non-standard type. Table II below illustrates one exemplary matrix of client type/facility type that could be deemed to encompass a standard type credit request.

TABLE II

| CLIENT TYPE | FACILITY TYPE | AMOUNT | MATURITY |
|---|---|---|---|
| Individual.Sole | Cash Advances | 2.0 m CHF | 12 months |
| Individual.Joint (or) | Fixed Advances | | |
| Individual.Collective | ETD | | |
| (and) | | | |
| Private Investment | FX Margin Trading | | |
| Company | Credit Card facility | | |
| (PIC) | | | |

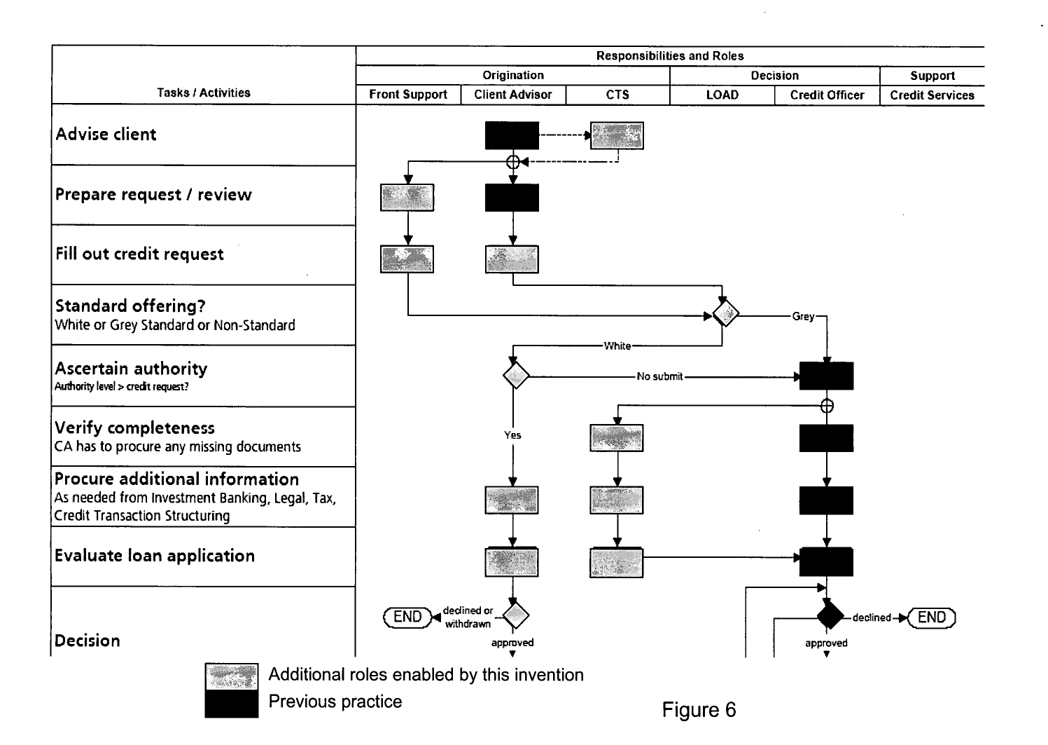

One result of the automatic categorization of credit requests into “grey” and “white” categories provide by embodiments of the present invention is a rebalancing of work tasks within a lending institution. FIGS. 6-8 are schematic diagrams that depict the partitioning of various tasks between different lending entities, in the context of the workflow enabled by the automatic decision tool of the current invention.

FIG. 6 illustrates a series of tasks involved between the time a client considers applying for credit and a decision is made upon the application. As illustrated, the role of the CA in advising the client in reviewing a credit request persists. However, because information is now sent to an automated decision tool, the CA can also assume the role of preparing a credit request to send to the automated decision tool. In addition, front support personnel can prepare/fill out credit requests. The automated decision tool acts as a gatekeeper for the CO decisionmaker, such that “white” cases can be screened from the CO and sent to the CA for processing. The CO is still responsible for verifying completeness, procuring further loan information, and making a final loan application evaluation, in “grey” cases. However, the CTS and CA can also participate in those steps, the latter entity participating in procuring information and evaluating the final loan application before rendering a final decision, in the case of “white” credit requests. Because the majority of credit requests may fall into the “white” category, the CO may substantially participate in only a small percentage of cases, while the majority is routinely handled by the CA.

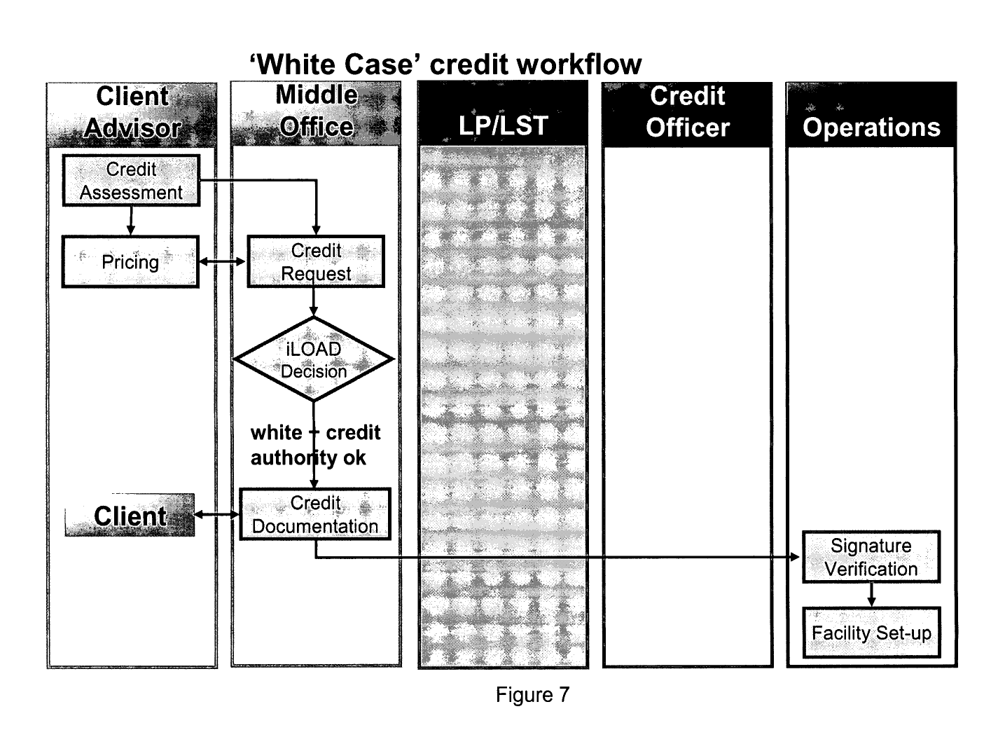

FIG. 7 is a schematic diagram that illustrates an exemplary process flow in the case of a credit request that is classified as “white,” in accordance with an embodiment of the present invention. The CA can participate in an initial credit assessment before a credit request is prepared and sent to a “Middle Office” where an automated decision tool makes the determination that the credit request is a “white” case. Credit documentation can also be performed at the Middle Office, while verification and facility set up are handled by an Operations system. The CO plays no role in the entire transaction.

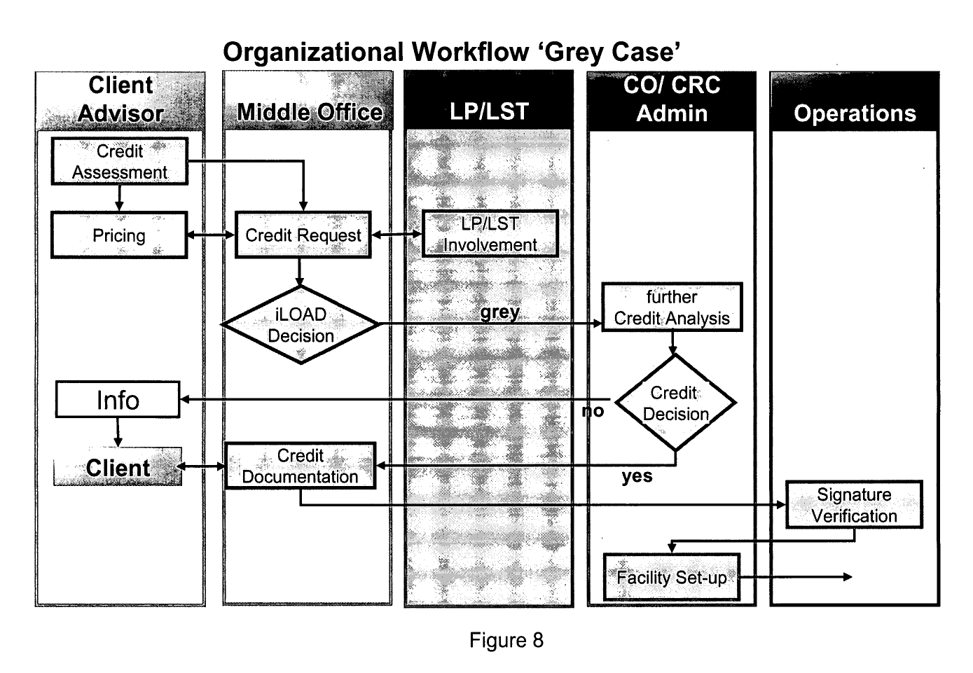

FIG. 8 is a schematic diagram that illustrates an exemplary process flow in the case of a credit request that is classified as “grey,” in accordance with an embodiment of the present invention. In this case, the CO manually performs further credit analysis. For example, the CO may scrutinize the results of decision criteria questions that resulted in “grey” answers to determine if further information is needed. The CO is then responsible for a final decision on whether to approve the credit request. After verification of an approved request, the CO/CRC is also responsible for Facility set-up.

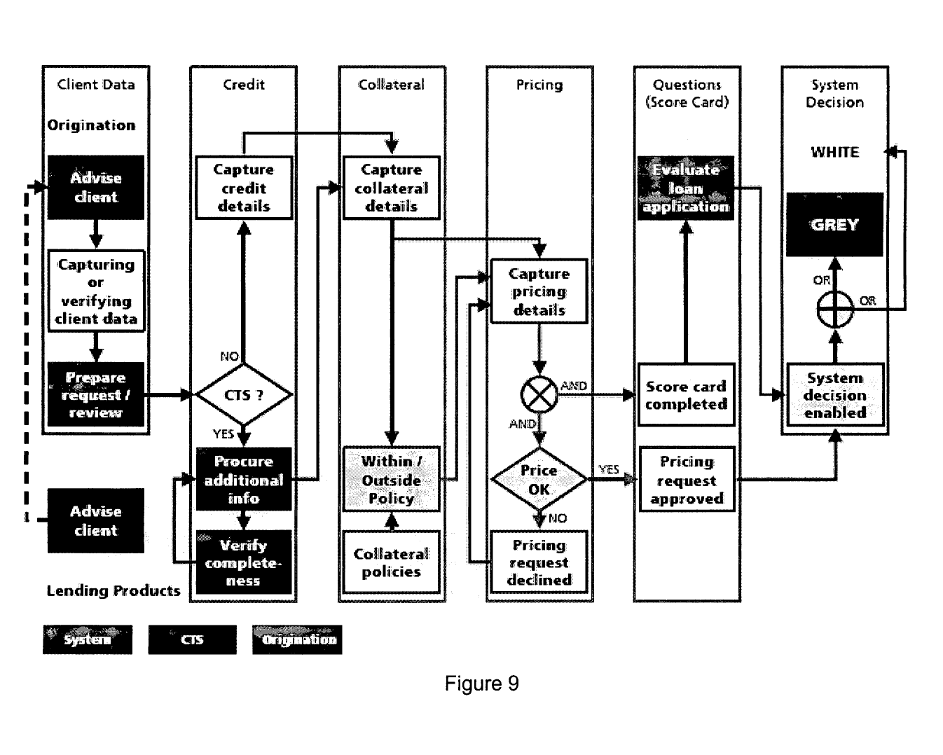

In addition to performing evaluations to determine whether a credit request is to be classified as “white” or “grey,” in other embodiments of the present invention, an automated decision tool can be configured to output pricing information related to a credit request. FIG. 9 is a schematic diagram that depicts details of process inputs used to determine pricing of a credit request using an automated decision tool, in accordance with another embodiment of the present invention. After basic client data is captured, for example, in conjunction with a CA, credit and collateral information is feed into an automated decision tool to generate approval of a pricing request in parallel with the evaluation of the credit request (loan application). An approved pricing request is fed to the system, which determines whether the credit request is classified as “grey” or “white.” In either “grey” or “white” case, the pricing information can be used in conjunction with the final evaluation of the loan application.

In other embodiments of the present invention, a system for credit request processing can be configured to improve “grey” case identification by learning from data extracted from credit request processing performed by the system. For example, the percentage of “grey” cases can be reduced by purging or modifying questions that unnecessarily lead to credit requests being accorded a “grey” status, or by changing decision logic that accords excessive weight or too little weight to decision criteria questions.

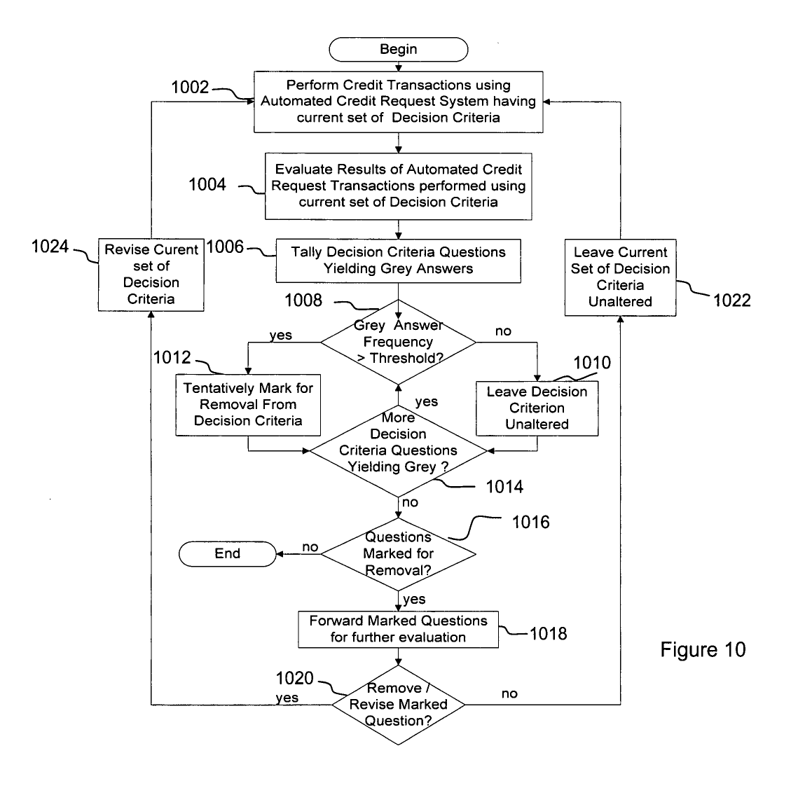

FIG. 10 illustrates exemplary steps involved in a method for improving credit request processing, in accordance with another embodiment of the present invention.

In step 1002, an automated credit request system is used to perform a series of credit request transactions (loan applications) based on a first set of decision criteria. The first set of decision criteria may, for example, include questions depicted in Table I above. Based on the decision criteria, the series of loan applications is processed in which some cases are categorized as “white” and some categorized as “grey.”

In step 1004, the results of the automated credit request transactions are evaluated. For example, if a lending institution desires to reduce the amount of grey cases, at least those deemed to be classified unnecessarily as “grey,” the credit request system may be configured to facilitate scrutiny of all loan cases that employ a current (first) set of decision criteria, to see if the set of decision criteria can be improved. The evaluation can comprise data mining to categorize the results and inputs of cases according to any desired criteria.

In one example, the decision logic employed by an automated decision tool may be configured to determine a “grey” status for a credit request based on scoring of a series of answered yes/no questions, which individually are marked as “grey” or “white.” The overall categorization of a loan application as “grey” may result, for example, from a threshold of individual “grey” answers being received. Accordingly, any questions that consistently score “grey” answers during processing of credit requests, will increase the likelihood that credit requests will be denied. It may therefore be useful to identify and scrutinize those questions that consistently score “grey” answers to determine if the questions can be modified or discarded.

In step 1006, decision criteria questions that yield “grey” are identified and tallied.

In step 1008, for each decision criteria question, the frequency of “grey” answers can be tallied and compared to a threshold frequency. The threshold may be set individually for each particular question or globally to apply the same value for all questions. For example, a lender may determine that a target ratio of “grey” to “white” cases is about 1:5. The lender may further determine that any question that yields “grey” answers for client applications received at a frequency above 50% is not useful as a means for evaluating a credit request, because it is otherwise known, for example, that a very high percentage of the set of clients applying for loans should qualify for “white” processing. Such a question could then be targeted for modification or discarding.

In step 1008, if the frequency threshold is not exceeded, the process moves to step 1010, in which the particular decision criterion is left unaltered.

In step 1008, if the frequency threshold is exceeded, then the process moves to step 1012, where the automated decision tool tentatively marks the question for removal from the set of decision criteria used by the automated decision tool.

In step 1014, if more decision criteria that yield “grey” results remain to be evaluated, the process moves back to step 1008.

In step 1014, if no more decision criteria that yield “grey” results remain to be evaluated, the process moves to step 1016.

In step 1016, if there are no questions tentatively marked for removal, the process ends. If there are questions tentatively marked for removal, the process moves to step 1018.

In step 1018, the marked questions are forwarded for evaluation. For example, a lender might require that all stakeholders in the credit request process review and comment on the marked questions to determine if the questions can be reworked to produce less “grey” results when applied to typical client requests.

In step 1020, each marked question is evaluated to see if it should be removed or revised. If the question is not determined to need revision or removal, the process moves to step 1022, where the current set of decision criteria remains unaltered.

If the question might be determined to require removal or revision, the process moves to step 1024.

In step 1024, the current set of decision criteria is updated to reflect the removed or revised decision criteria. The process then moves to step 1002 where credit request transactions are performed using the updated criteria.

The above process outlined in FIG. 10 limits the amount of “grey” cases by removal of questions that too frequently yield an individual “grey” answer during the automated evaluation of a credit request. By reducing the amount of questions that are determined to over-produce “grey” answers, the overall likelihood that a credit request or a series of credit requests will exceed a “grey” answer threshold and thereby be categorized as “grey” is reduced.

However, other methods of reducing the percentage of credit request that receive a “grey” rating are possible.

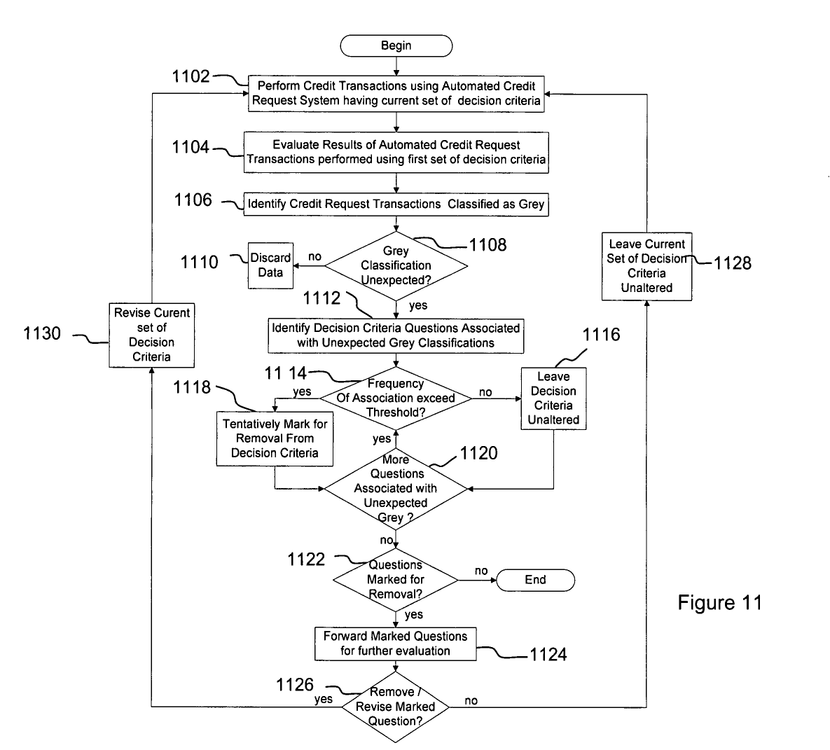

FIG. 11 illustrates exemplary steps involved in a method for improving credit request processing, in accordance with another embodiment of the present invention.

In step 1102, an automated credit request system is used to perform a series of credit request transactions (loan applications) based on a first set of decision criteria, as described above with respect to FIG. 10.

In step 1104, the results of the automated credit request transactions are evaluated.

In step 1106, the system identifies credit request transactions that were classified as “grey.” For example, in a list of two hundred transactions, the system may return a list of fifty transactions that were classified as “grey” and were processed by a CO.

In step 1108, each transaction is probed to determine if the classification of that transaction as “grey” was unexpected. Table III below illustrates an example of how the determination in retrospect of whether the classification of a previous credit request as “grey” was unexpected.

TABLE III

| CLIENT TYPE | FACILITY TYPE | AMOUNT | MATURITY |
|---|---|---|---|
| Individual.Sole | Cash Advances | 2.0 m CHF | 12 months |
| Individual.Joint (or) | Fixed Advances | | |
| Individual.Collective | ETD | | |
| (and) | | | |
| Private Investment | FX Margin Trading | | |
| Company | Credit Card facility | | |
| (PIC) | | | |

Table III contains exemplary features that could represent those criteria which, if satisfied, would lead to a credit request being classified as “white.” Thus, a client that is a sole individual applying for cash advances of less than 2.0 m CHF with a maturity of less than 12 months would be expected to have a credit request accorded a “white” status, in which the CA handles processing and approval. In other words, a classification based on a basic profile of the case reflected in Table III would result in a “white” classification. If a case having such a profile received a “grey” status during the loan application process, the system using an automated process could determine after the fact that the case involved an “unexpected” classification as “grey.” Alternatively, such a determination could be made by lender personnel reviewing the case.

In step 1108, if the “grey” status accorded credit requests being examined was not unexpected, the process moves to step 1110, where the data associated with the requests is discarded.

In step 1108, if one or more of the credit requests was determined to be an “unexpected grey” case, the process moves to step 1112, where the system identifies decision criteria questions associated with the unexpected “grey” classification. Thus, a series of credit requests could be identified as producing “unexpected grey” results based on, for example, the considerations discussed above with respect to step 1108. From the series of “unexpected grey” transactions, a list of decision criteria questions that resulted in “grey” answers in the “unexpected grey” transactions can be compiled.

In step 1114, a level of correlation between the decision criterion yielding “grey” answers and the occurrence of an “unexpected grey” classification is examined. For example, the frequency of association of individual decision criteria questions with an “unexpected grey” result for a credit request can be examined. It might be determined that, for example, a high proportion of all “unexpected grey” cases are associated with one or more decision criteria questions also being “grey.” If this proportion exceeds a threshold fraction, the process moves to step 1118, where the system could flag the decision criteria questions or set of questions for possible removal.

If the proportion of “unexpected grey” cases that are associated with the identified decision criteria is not above a threshold, the process moves to step 1116, where the decision criteria in question are not altered.

In step 1120, if there are further decision criteria identified from step 1112, the process reverts to step 1114. If no further decision criteria remain to be evaluated, the process moves to step 1122.

In step 1122, if there are no decision criteria marked for possible removal, the process ends. If there are decision criteria marked for possible removal, the process moves to step 1124.

In step 1124, the marked questions are forwarded for further evaluation. As described above, the questions could be examined by a group of stakeholders to determine whether to modify or remove the questions. If it is determined that a question has not improperly caused an otherwise good “white” credit request to be classified as “grey” the determination may be made to leave the question as is, in which case the process moves to step 1128, where the current set of decision criteria is not changed.

If, on the other hand, the determination is made that otherwise “white” cases are being improperly transformed into “grey” cases based on the presence of the decision criterion question of interest, then the question may be altered or removed. In step 1130, the current set of decision criteria is altered to reflect the changes or deletions related to decision criteria questions that were flagged as contributing to unwanted and unexpected “grey” classification of credit requests. For example, a culprit question might be designed to elicit information about the client, but might be structured in such a manner that it yields a “grey” answer too frequently. Once identified, the question could be reformed or removed if it is determined that the information elicited is not crucial or can be obtained in other ways.

In one embodiment of the present invention, an automated decision tool is provided with a mechanism to adjust the credit decision making process to take into account user characteristics that can influence the credit-related decision making process. For example, the scoring of a credit request can be based on a series of questions that relate to different criteria, as illustrated in FIG. 5 and Table I above. Because many of the questions are structured in a yes/no format requiring user input, the scoring of the credit request can be influenced by the accuracy to which the user inputs answers to the questions. Furthermore, in order to provide a yes/no answer to many of the questions, the user may have to interpret information and documents available to the user. For example, new employees of a lender might tend to generate more “grey” or “declined” responses to questions when presented with the same objective data. This is because the new employees would not be familiar with a client or conditions of a case associated with a particular credit request, and thus might tend to act more conservatively than optimal in determinations of answers to questions, where the conservative action would be to generate more “grey” responses so that credit is not erroneously extended to a non-creditworthy request. The result of this “bias” would be the generation of excessive “grey” (or even “declined”) overall scoring of credit requests, such that unnecessary credit requests are funneled through a credit officer for review.

Therefore, in accordance with embodiments of the present invention, the scoring-results can be used to develop, for example, an Expert System that is able to change decision logic according to the degree of user experience.

In a further aspect of the present invention, storing background information of a client enables an existing client itself to answer decision criteria questions (client self-score) instead of the CA. In other words, the client can be permitted direct access to (i.e., to directly interface with) the system 200 (e.g., through an Internet website), answer the decision criteria questions, and receive a credit answer, which would be based on the stored client background information and the client's answers to the questions. In this direct access embodiment, customers are able to input the requested data and obtain an immediate decision on their credit request. If the request is granted, the loan documentation can be completed through the use of electronic signatures or through paper documentation that is created automatically.

The extent to which a client is allowed direct access can depend on a client confidence index that is calculated based on historical data and access to customer data within the system that is indicative of the available collateral. In a preferred embodiment the collateral is continually monitored to ascertain and changes to the credit risk.

In the direct access process the information input by the customer and the decision may be routed to the client advisor as desired to keep the client advisor informed and to allow review by the client advisor.

In one aspect of the invention, the client self-scoring of a credit request (client self service process) is performed in accordance with procedures outlined above with respect to Table I and FIG. 5. In a “white” case, the credit request can be approved nearly immediately. In a “grey” case, the request would involve the evaluation and decision of a CO. In either case, a CA would not have to be involved in the scoring process.

The scope of the client self-scoring can be limited according to criteria that are determined by the lender. For example, the client self-serve scoring could be made available up to a certain ceiling in monetary value of the credit request, according to duration of the loan, relationship of the client and lender, and other lending criteria. For example, a first monetary threshold for credit requests could be set below which a decision to grant credit can be self-generated by the client. For credit requests whose monetary value exceeds the first threshold but is below a second threshold that represents the limit of the authority for the CA, the CA would be required to check and approve the client's self-service request. Above the CA's credit authority (the second threshold) the CO would be required to approve the credit request.

In one embodiment of the present invention, after the scoring of the self-service credit request, the result of the scoring is provided to the client so that the client is apprised as to whether the request is being given expedited or deliberate (“grey”) treatment.

. As a further benefit, the system 200 could archive the client's answers to the decision criteria questions in case a dispute over the terms of the credit agreement arose in the future. The lending institution could then present the client's answers as the basis of the agreement terms. Along these lines, a further aspect of the present invention provides that the decision criteria questions and answers cannot be changed by a client or a CA, so as to preserve the audit trail.

In summary, one aspect of the invention is that the information technology based automated credit evaluation/decision system and method may be fully integrated from end-to-end within a multinational financial institution. In addition to the efficiencies resulting form integration, housing the system within a single institution is important because sensitive financial information may be maintained within a single institution. Further, through integration, the system and method of the present invention ensure that credit decisions are based uniformly upon best practices and institution wide knowledge base reflecting the collective wisdom and experience of the entire institution. With access to the institutions integrated systems, the system and method of the present invention is particularly useful in the context of the credit decision process relating to collateralized loans to existing customers of a financial institution that is holding the collateral. In this regard, the automated credit evaluation/decision system may be integrated into an overall system that includes a credit monitoring and reporting system that allows continual monitoring of collateral and can access existing data from institution databases to determine, for example, the collateral or pledgeable assets a client has, the client's credit history with the lending institution (sometimes referred to as a “customer confidence index”), and the particular local regulatory and legal restrictions that apply to the client.

By virtue of this system and method architecture and the underlying information technology, it is possible to process credits requests immediately. This provides the customer a tremendous benefit, by not simply making a credit decision, but rather leveraging institutional knowledge to simplify the request intake (by using previously stored information), expediting a credit decision (by using information stored in the system regarding the collateral) based upon consistent set of best practices (that reflect the collective wisdom and experience of the institution) and, where appropriate, generate and complete necessary documentation (electronic or paper) to complete the transaction.

As described, the credit decision is output as “white” or “grey (standard)” or “grey non-standard.” If the decision is “white,” then the system will generate documents and solicit client signature immediately. If the decision is “grey standard,” then the system will generate documents and pass the documentation to the credit officer (but do not solicit client signature immediately). If the decision is “grey non-standard,” then the system will generate standard documents with the option for the CO to add or change special paragraphs.

Automatic generation of documentation ensures that the correct documents are used and that the documentation cannot be altered. Thus the documentation used is the very best possible based upon the collective wisdom and experience of the institution. Naturally, automatic generation of documentation also improves efficiency and productivity and makes it possible to provide an exceptional “one-stop” client experience.

Another feature of the invention is a maintenance process/tool that allows the institution to review the details of the grey cases and statistics related to the number of grey cases to obtain feedback on why cases ore grey and to improve the system and process.

The system and method of the present invention are designed to provide feedback to ensure continual improvement and learning of both users (typically client advisors) and the system itself. The client advisors using the system receive immediate feedback based upon the collective wisdom and experience of the institution. Immediate feedback on why a decision is grey, not white is provided to the client advisor and CO to improve their knowledge and future use of the system. Credit Risk Control regularly analyses reports out of iLOAD System with the aim to further streamline the system.

The system and method of the present invention also include auditing and control functionality to ensure that credit decisions are made based upon a consistent set of criteria that reflects the collective wisdom and experience of the institution. The system enforces the institutions best practices in terms of both the decision process and documentation and maintains records of any deviation.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. For example, in addition to the methods disclosed with respect to FIGS. 10 and 11, other mechanisms for identifying and eliminating decision criteria that unnecessarily contribute to “grey” classification of credit requests are possible.

The steps described herein are performed using general purpose information technology infrastructure that is programmed to function as described herein. The information technology infrastructure includes one or more databases for storage and software engines and processors for performing the steps described herein.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible.

Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. In a financial institution operating in a plurality of jurisdictions and holding loans against which collateral is pledged, the financial institution having access to data records storing information including a loan identification (ID), a client ID associated with each loan ID, collateral associated with each loan ID, and jurisdiction information associated with each client ID, a method for processing credit requests for which assets are pledged as collateral, the method comprising:
receiving a credit request associated with a client, wherein the client has a plurality of assets within the custody of the financial institution;
identifying from the data records preset criteria comprising the client's collateral based on the plurality of assets, the client's credit history with the financial institution, and the local regulatory and legal restrictions applicable to the client;
applying credit request evaluation rules to the preset criteria to determine if the credit request satisfies the rules;
if the credit request meets the rules, immediately approving the credit request; and
if the credit request does not meet the rules, forwarding the credit request to a credit officer for approval.

2. The method of claim 1, wherein if the credit request meets the rules, the method further comprises selecting based upon the jurisdiction information the requisite credit documentation, populating credit documentation based on the data records, and generating the credit documentation for the client's signature.

3. The method of claim 2, wherein if the credit request does not meet the rules, the method further comprises determining whether the sufficient information is available to generate the requisite credit documentation and, if so, populating the credit documentation based on the data records, generating the credit documentation, and forwarding the credit documentation to the credit officer.

4. The method of claim 1, wherein the credit request is received from the client through a direct interface.

5. The method of claim 1, wherein the financial institution comprises a multinational financial institution.

6. The method of claim 5, further comprising:
storing in a central global data warehouse data identifying the client's assets in different jurisdictions of the multinational financial institution;
continually and automatically calculating the collateral value of the client's assets; and
applying the credit request evaluation rules using the collateral value.

7. The method of claim 1, further comprising:
anonymizing credit requests that do not meet the rules;
storing the anonymized credit requests in a central global data warehouse, along with associated data indicating how each credit request was resolved by a credit officer; and
modifying the credit request evaluation rules to maximize the number of credit requests that meet the rules.

8. In a financial institution operating in a plurality of jurisdictions and holding loans against which collateral is pledged, the financial institution having access to data records storing information including a loan identification (ID), a client ID associated with each loan ID, collateral associated with each loan ID, and jurisdiction information associated with each client ID, a method for processing credit requests comprising:
receiving a credit request associated with a client at an automated decision tool;
identifying from the data records preset criteria comprising the client's collateral, the client's credit history with the financial institution, and the local regulatory and legal restrictions applicable to the client;
scoring the credit request according to the preset criteria;
determining whether the credit request merits further review based on the scoring the credit request; and
approving the credit request if the credit request does not merit further review.

9. The method of claim 8, wherein the client's collateral is limited to collateral held by the financial institution.

10. The method of claim 8, wherein scoring the credit request is based at least in part on answers to a plurality of scoring questions, the answers provided by a user of the automated decision tool.

11. The method of claim 10, wherein access to the automated decision tool is provided to a client for self-scoring if pre-set criteria are met.

12. The method of claim 10, wherein scoring the credit request is based on an experience level of the user.

13. A method for improving credit request processing, comprising:
performing credit request transactions using an automated credit request system operable using a first set of decision criteria;
evaluating a set of results associated with the credit request transactions;
identifying a decision criterion of the first set of decision criteria that scores a first response based on the evaluating of the set of results;
evaluating whether a frequency of scoring of the first response exceeds a threshold; and
marking the decision criterion for removal from the first set of decision criteria if the threshold is exceeded.

14. A method for improving evaluation of credit requests, comprising:
performing a plurality of credit request transactions using an automated credit request system operable using a first set of decision criteria;
evaluating a set of results associated with the credit request transactions;
identifying, from the plurality of credit request transactions, a set of credit request transactions classified for further review;
determining, from the set of transactions classified for further review, a subset of transactions whose basic profile does not classify the subset of transactions for further review;
identifying a decision criterion that yields a first response within the subset of transactions;
determining a level of correlation between the decision criterion and the subset of transactions; and
marking the decision criterion for removal if the level of correlation exceeds a threshold.

15. A system for credit request processing, comprising:
an automatic decision tool configured with a decision logic;
a database of credit request data accessible to the automatic decision tool, wherein the automatic decision tool is configured as a single point of entry for credit request data received by a lender;
an anonymizer configured to provide the credit request data in anonymized form to users not authorized to view unanonymized client information; and
a database of decision criteria accessible to the automatic decision tool, wherein the automatic decision tool, using the decision logic, is operable to produce a series of scores based on the decision criteria and the credit request data, wherein the system is configured to classify a credit request for expedited approval if scores for the credit request do not exceed a predetermined threshold, and wherein the system if configured to produce a set of predetermined documents for completion of the credit request according to the scoring logic and answers to the decision criteria.

16. In a financial institution operating in a plurality of jurisdictions and holding loans against which collateral is pledged, the financial institution having access to data records storing information including a loan identification (ID), a client ID associated with each loan ID, collateral associated with each loan ID, and jurisdiction information associated with each client ID, a method for processing credit requests for which assets are pledged as collateral, the method comprising:
providing an interface for allowing a client to input a credit request associated with the client;
receiving from the client through the interface a credit request associated with the client, wherein the client has a plurality of assets within the custody of the financial institution;
monitoring the value of the plurality of assets and providing a data record, on at least a daily basis, reflecting the current value of the plurality of assets;
identifying from the data records preset criteria comprising the client's collateral based on the plurality of assets, the client's credit history with the financial institution, and the local regulatory and legal restrictions applicable to the client;
applying credit request evaluation rules to the preset criteria to determine if the credit request satisfies the rules;
if the credit request meets the rules, immediately approving the credit request; and
if the credit request does not meet the rules, forwarding the credit request to a credit officer for approval.

17. The method of claim 16, wherein if the credit request meets the rules, the method further comprises selecting based upon the jurisdiction information the requisite credit documentation, populating credit documentation based on the data records, and generating the credit documentation for the client's signature.

18. The method of claim 17, wherein upon execution of the credit documentation, the method further comprises making funds available to the client.

19. The method of claim 18, wherein the credit documentation comprises electronic documentation, the client executes the credit documentation via an electronic signature, and the funds are made available electronically.

20. The method of claim 16, wherein the evaluation rules are based on the financial institution's best practices and are uniformly applied throughout the financial institution, and the method further comprises revising the evaluation rules based on feedback resulting from practice of the method.
